(19) United States
(12) Patent Application Publication
(10) Pub. No.: US 2014/0095405 A1
(43) Pub. Date: Apr. 3, 2014

(54) AUTOMATED NOTIFICATION DEVICE

(71) Applicant: LYNGSOE SYSTEMS LTD., Mississauga (CA)

(72) Inventors: Don FERGUSON, Maple (CA); Alex OPREA, Toronto (CA)

(73) Assignee: LYNGSOE SYSTEMS LTD., Mississauga (CA)

(21) Appl. No.: 14/044,300

(22) Filed: Oct. 2, 2013

Related U.S. Application Data
(60) Provisional application No. 61/708,953, filed on Oct. 2, 2012.

(51) Int. Cl. G06Q 10/08

(52) U.S. Cl. CPC G06Q 10/083
USPC 705/330

(57) ABSTRACT

An automated item notification device is described. The automatic notification device is configured to be secured within a drop box and comprises a communication module, a deposit sensor, a camera and processor. The communication module communicates with a remote resource. The deposit sensor senses deposit of an object and provides a wake-up signal in response thereto. The camera captures an image of an interior of the drop box in response to the wake-up signal. The processor is configured to compare the captured image with a previously acquired reference image stored in memory to determine if the object has been received in the drop box. In response to detection that the objected has been received in the drop box, a message is transmitted to the remote resource that the drop box needs to be serviced, and the processor enters an extended sleep mode. In response to detection that the objected has not been received in the drop box, the processor enters a sleep mode. A method for operating the automatic item notification is also described.

The present invention relates generally to drop boxes for pickup services and specifically to a method and device for automatic notification of receipt of an item at the drop boxes. This application claims priority from U.S. Provisional Application No. 61/708,953, titled “Automated Notification Device” and filed Oct. 2, 2012.

### BACKGROUND

Express and overnight parcel delivery services have become part of everyday business in today's competitive economy. Parcels are picked up at a variety of locations, including customer locations, drop boxes, parcel processing companies, the parcel delivery service office, and the like.

Drop boxes are a way for parcel delivery service providers to provide a relatively large number of parcel drop-off points without incurring significant overhead or staffing costs. However, in order to provide efficient service, the parcel delivery service provider has to schedule regular visits to each of the drop boxes regardless of whether any parcels have been deposited. Thus, the required steps of driving to each location and inquiring whether a parcel is being picked up increases the operating costs of the parcel delivery service provider in both staffing and fuel.

Accordingly, the parcel delivery service provider is left with the choice of either strategically placing each drop box to optimize the pick-up route at the expense of drop box placement, or optimizing the drop box placement at the expense of pick-up route.

In order to solve this problem, a number of solutions have been proposed. For example, U.S. Pat. No. 5,818,336 to Varga et al. discloses apparatus and methods for controlling and monitoring pickup of packages deposited in a system of drop boxes, wherein each such drop box is adapted to receive a plurality of packages through a door, includes a drop sensor which is adapted to sense the deposit of a package through the door, means for communicating a plurality of signals indicative of the deposit of such package through the door, and a power supply which is operatively coupled to the drop sensor and communicating means for providing a source of power thereto. The drop sensor generally comprises means for passively detecting the passage of packages, and means for generating the plurality of signals indicative of the deposit of such packages through the door. Such plurality of signals include a signal to indicate that the drop box is approaching a “full box” condition, a signal to indicate that the drop box is at such “full box” condition, and a “pickup” signal to indicate that the courier has completed his daily rounds.

In another example, U.S. Patent Application Publication No. 2005/0154602 by Hertz discloses various methods and apparatus to increase efficiency in the parcel pick up process. Two types can be applied, a wireless parcel deposit monitoring apparatus is installed into a parcel drop box, and a wired parcel pick up request which is located within a customer pick up location. The wireless parcel deposit monitoring apparatus would identify when a parcel is deposited into the parcel drop box and send a request for pick up message to a host computer. The wired parcel pick up request apparatus is a simplistically operated apparatus, wherein the user would simply press a button to request a pick up. The wired parcel pick up request would communicate with a host computer using a wired communication network (Ethernet, Modem, and the like). The host computer would determine if the request for pick up can or cannot be accommodated, and respond to the wired parcel pick up request apparatus accordingly. The wired parcel pick up request apparatus would convey the response to the user.

In yet another example, U.S. Patent Application Publication No. 2011/0137484 by Poss et al. discloses a package deposit enclosure designed for public use is powered by an efficient storage battery and photovoltaic cell array. These unique features allow the package deposit enclosure to be placed in locations where no power is available, but where there is frequent human traffic. Sensing and wireless data communication features allow the unit to be emptied less often than typical package delivery enclosures. Wireless communication also allows users' access to real-time information. On board power enables other functions, such as lighting and audio, to enhance device functionality.

Accordingly, there is a need for an automated parcel notification device that can be used at a drop box to obviate or mitigate at least some of the problems described above.

### SUMMARY

In accordance with an aspect of an embodiment, there is provided an automated item notification device configured to be secured within a drop box, the automated item notification device comprising: a communication module configured to communicate with a remote resource; a deposit sensor configured to sense deposit of an object and provide a wake-up signal in response thereto; a camera configured to capture an image of an interior of the drop box in response to the wake-up signal, and a processor configured to: compare the captured image with a previously acquired reference image stored in memory to determine if the object has been received in the drop box; in response to detection that the objected has been received in the drop box, transmit a message to the remote resource that the drop box needs to be serviced, and enter an extended sleep mode; and in response to detection that the objected has not been received in the drop box, enter a sleep mode.

In accordance with a further aspect of the present invention there is provided a method for automatically notifying a local service provider to service a drop box, the method comprising the steps of: sensing deposit of an object by a deposit sensor; providing a wake-up signal in response to the sensed deposit; capturing an image of an interior of the drop box in response to the wake-up signal; comparing the captured image with a previously acquired reference image stored in memory to determine if the object has been received in the drop box; in response to detection that the objected has been received in the drop box, transmitting a message to a remote source and entering an extended sleep mode; and in response to detection that the objected has not been received in the drop box, entering a sleep mode.

### BRIEF DESCRIPTION OF THE DRAWINGS

Embodiments of the invention will now be described by way of example only with reference to the following drawings in which:

FIG. 1 is a block diagram of an automated parcel notification system;

FIG. 2 is a block diagram of a package notification device;

FIG. 3 is a flow chart illustrating operation of the automatic parcel notification;

FIG. 4 is a flow chart illustrating operation of the automatic parcel notification in accordance with an alternate embodiment;

FIG. 5 is a flow chart illustrating operation of the automatic parcel notification in accordance with yet an alternate embodiment.

### DETAILED DESCRIPTION OF THE PREFERRED EMBODIMENTS

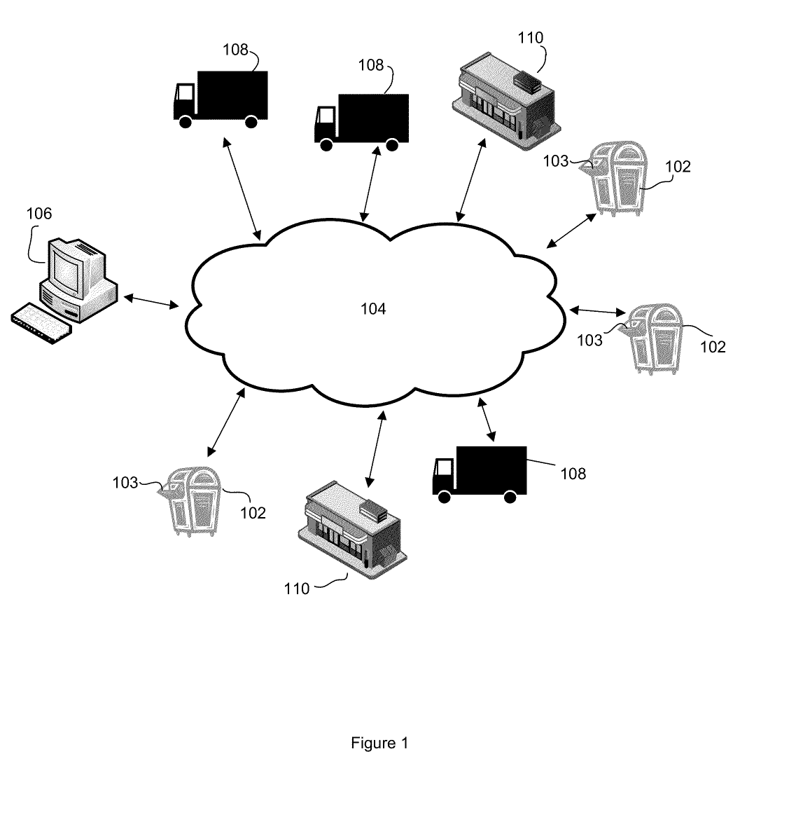

For convenience, like numerals in the description refer to like structures in the drawings. Referring to FIG. 1, a network for automated package notification is illustrated generally by numeral 100. The network 100 includes a plurality of drop boxes 102, a communication network 104, a central control station 106, a plurality of transport vehicles 108 and a plurality of local agents 110.

The drop boxes 102 are configured to allow a customer to deposit a parcel and include deposit door 103 for receiving parcels from the customer, a pick up door (not shown) for facilitating parcel pick-up, and a package notification device (not shown) for detecting the parcel and notifying the central control station 106 accordingly. The configuration, shape and size of the drop boxes 102 may change depending on the implementation. The drop boxes 102 communicate with the central control station 106 via the communication network 104. Accordingly, the communication network 104 may include a Wireless Wide Area Network (WWAN) configured to facilitate wireless communication. The WWAN may include a cellular network such as a 3G network, a long term evolution (LTE) network, an evolution-data optimized (EV-DO) network, WiMAX or the like. Alternatively, or additionally, the communication network may include a wired wide area network (WAN). The WAN includes an access point (not shown) that can be accessed wirelessly using a Wireless Local Area Network (WLAN) such as a Wi-Fi network. As will be appreciated by a person of ordinary skill in the art, the configuration of the communication network 104 can vary depending on the implementation.

A parcel notification device is positioned to capture an image of the interior of the drop box 102 so that it can be confirmed that a parcel has been deposited. The parcel notification device is also positioned to reduce the likelihood of it being struck by a parcel that has been deposited. If the notification device is not located in such a position, then additional steps may be taken to reduce the likelihood or effect of such an occurrence. Accordingly, in this embodiment, the parcel notification device is mounted to the ceiling of the drop box 102.

The parcel notification device can be mounted to the drop box 102 using a number of different techniques. For example, the parcel notification device can be mounted to the drop box 102 using an adhesive or Velcro®. Further, screws and brackets can be used to mount the parcel notification device. Yet further, a housing may be molded into the interior of the drop box 102 to house the parcel notification device.

The control station 106 is configured to receive information from the drop boxes 102 and relay the information to one or more of the transport vehicles 108 and/or one or more of the plurality of local agents 110. The control station 106 may be configured to operate on the received information automatically or it may require the involvement of an operator. Each of the transport vehicles 108 are assigned to a general region for picking up, and possibly delivery of, parcels. The regions between different transport vehicles 108 may or may not overlap. The local agents 110 are physical store fronts that are affiliated with a corresponding one or more of the drop boxes 102. Not all drop boxes 102 are necessarily associated with a local agent 110.

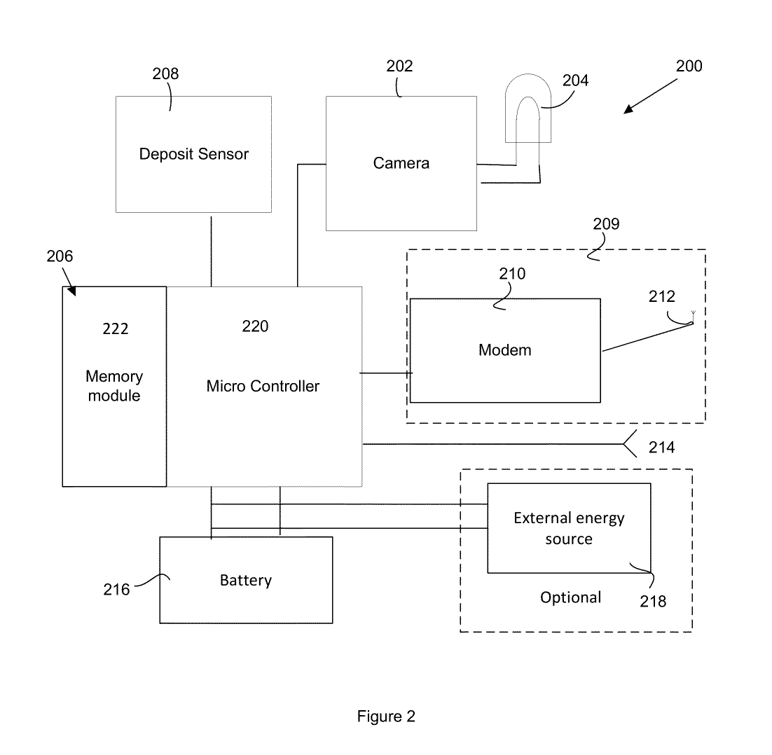

Referring to FIG. 2, the parcel notification device, illustrated generally by numeral 200, is shown in greater detail. The parcel notification device 200 includes a camera 202, a flash 204, a controller 206, a deposit sensor 208, a communication module 209, a data port 214 and a power source 216. The controller 206 includes a microcontroller 220 and memory 222. The communication module 209 includes a modem 210 and an antenna 212. The flash 204 is coupled to the camera 202. The antenna 212 is coupled to the modem 210. The camera 202, deposit sensor 208, modem 210, data port 214 and power source 216 are coupled to the processor 206. A person of ordinary skill in the art will appreciate that the parcel notification device 200 can be physically configured a number of different ways. For example, each of the camera 202, deposit sensor 208, modem 210, and data port 214 can be coupled directly to the power source 216.

In this embodiment the camera 202 is a standard, off-the-shelf imaging device. Accordingly, the camera is capable of auto-focusing. Although the camera 202 is illustrated as separate from the flash 204, the flash 204 and the camera 202 may be integrated into a single unit.

The controller 206 is configured to store software in the memory 222 for controlling operation of the parcel notification device 200. The data port 214 provides an external interface and can be used for diagnostics, data retrieval and system resets.

The deposit sensor 208 is configured to detect when a parcel is deposited into the drop box 102. In this embodiment the deposit sensor 208 is configured to detect vibration. That is, depositing a parcel into the drop box 102 causes vibration. The vibration may be a result of the customer physically opening the deposit door 103 or as a result of the parcel impacting the bottom of the drop box 102. Alternatively, the deposit sensor 208 may be configured to detect motion. Thus, as parcel falls in the drop box 102, its motion will be detected by the deposit sensor 208.

The modem 210 and the antenna 212 are configured to communicate over the communication network 104. Accordingly, the modem 210 can communicate using one or more of a plurality of different WWAN or WAN protocols. The communication may be transmitted using text messaging, data messaging, e-mail messaging or the like.

In this embodiment, the power source 216 is a battery pack. The battery pack 216 may or may not be rechargeable. Further, the parcel notification device 200 optionally includes a power connector 218 for connecting the controller 206 to an energy source (not shown). The energy source may be an external power supply, such as a plug or outlet. Alternatively, the energy source may be a renewable source, such as a solar source integrated into the drop box 200.

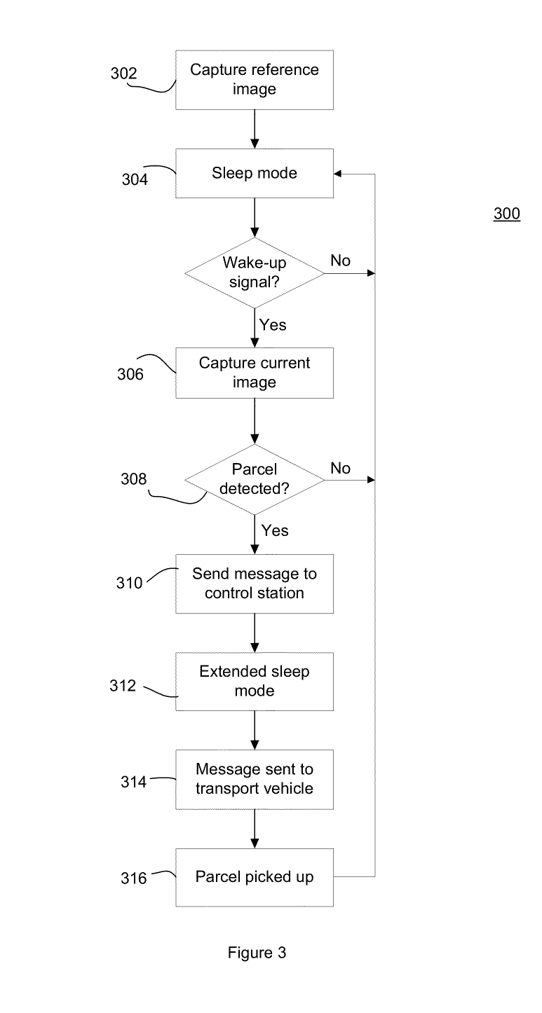

Referring to FIG. 3, a flow chart illustrating the operation of the parcel notification device 200 is illustrated generally by numeral 300. At step 302, a reference image is captured by the camera 202 and stored in the memory 222. At step 304, the parcel notification device 200 enters a sleep or power saving mode until it receives a wake-up signal from the deposit sensor 208. As will be appreciated, in the sleep mode, minimal power is consumed by the parcel notification device 200. The deposit sensor 208 provides the wake-up signal once its sensor is activated. In the example in which the deposit sensor 208 is a vibration sensor, the wake-up signal will be generated when vibration is detected.

Once the wake-up signal is received from the deposit sensor 208, then at step 306 the camera 202 captures a current image and stores it in the memory 222. The wake-up signal may be received at the camera 202 directly from the deposit sensor 208 or via the processor 206. A sensor delay may be instituted between receiving the wake-up signal and capturing the current image to inhibit capturing the current image too soon. For example, if the customer fumbles with the deposit door 103, it may be seconds or even minutes from the time vibration is detected until the parcel is actually deposited. Accordingly, the sensor delay may be implemented in the order of seconds or minutes. The sensor delay may be implemented at the deposit sensor 208, the processor 206 or the camera 202.

At step 308, the processor 206 compares the current image with the reference image to determine if there is a difference. A number of existing image comparison techniques may be used. In the present embodiment, the comparison is a bitmap comparison. A difference threshold is set to determine if the current image has changed substantially. If the difference between the current image and the reference image is less than the difference threshold, the current image is deleted and the parcel notification device 200 returns to sleep mode 304. If the difference between the current image and the reference image is greater than the difference threshold, the drop box 102 is considered to possibly contain a parcel.

At step 310, a message is sent to the control station 106 indicating that the drop box 102 may contain a parcel. The message includes a drop box identifier.

At step 312, the parcel notification device 200 enters an extended sleep mode in which even fewer resources are used than in the sleep mode. Since the message has been transmitted to the control station 106, it is no longer required to even detect further vibrations. Thus, in the extended sleep mode the deposit sensor 208 goes to sleep or is powered off. Alternatively, the camera 202 is configured to not respond to the wake-up signal.

At step 314, based at least in part on the drop box identifier, the control station 106 instructs a select one of the transport vehicles 108 to add the drop box 102 to its pick-up route. Selection of the transport vehicles 108 is based on one or more of the location of the drop box 102, the location of the transport vehicles 108, and a schedule route of the transport vehicles 108. That is, even though a first transport vehicle 108 may initially be closer to the drop box 102, the schedule route of a second transport vehicle 108 may take it even closer to the drop box 102.

At step 316, the operator of the selected transport vehicle 108, retrieves the parcels, if any, from the drop box 102 and resets the parcel notification device 200, which returns to sleep mode at step 304. Optionally, the parcel notification device 200 may return to step 302 and capture a new reference image.

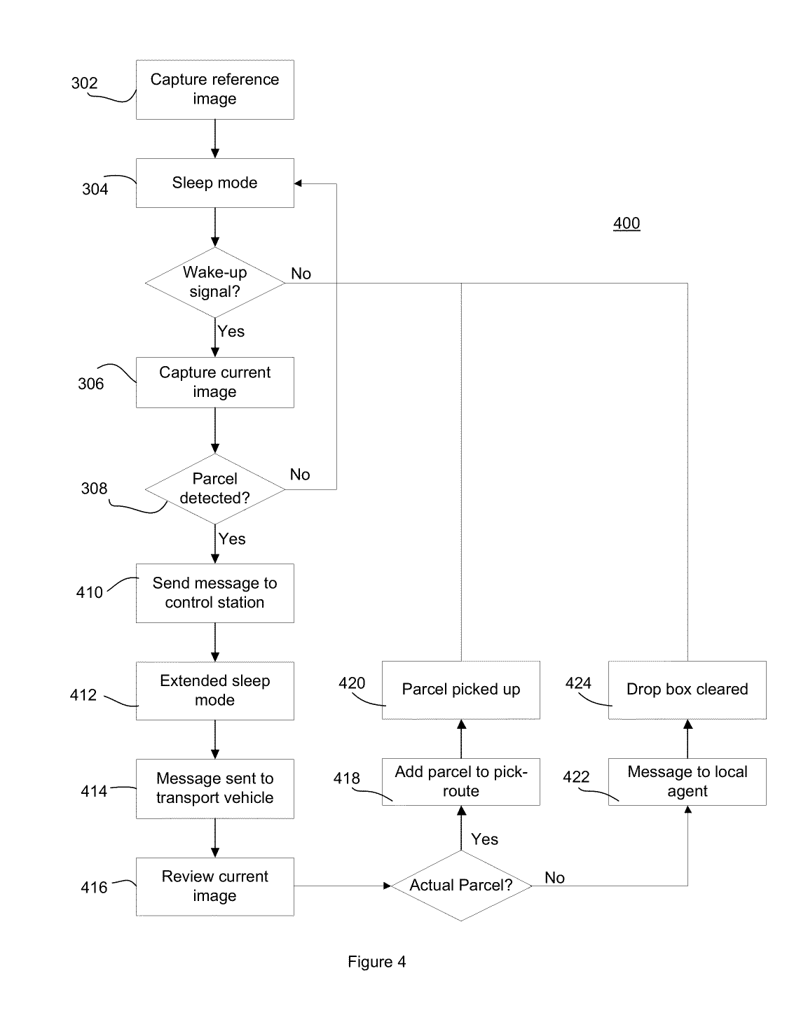

Referring to FIG. 4, a flow chart illustrating an alternate embodiment of the operation of the parcel notification device 200 is illustrated generally by numeral 300. As illustrated, steps 302 to 308 are the same as described in the embodiment described with reference to FIG. 3. Thus, at step 302, a reference image is captured by the camera 202 and stored in the memory 222. At step 304, the parcel notification device 200 enters a sleep or power saving mode until it receives a wake-up signal from the deposit sensor 208. Once the wake-up signal is received from the deposit sensor 208, then at step 306 the camera 202 captures a current image and stores it in the memory 222. At step 308, the processor 206 compares the current image with the reference image to determine if there is a difference. If the difference between the current image and the reference image is less than the difference threshold, the current image is deleted and the parcel notification device 200 returns to sleep mode 304. If the difference between the current image and the reference image is greater than the difference threshold, the drop box 102 is considered to possibly contain a parcel.

At step 410, a message is sent to the control station 106 indicating that the drop box 102 may contain a parcel. The message includes a drop box identifier and a copy of the current image. At step 412, the parcel notification device 200 enters the extended sleep mode.

At step 414 the control station 106 transmits the message to the selected one of the transport vehicles 108. At step 416, the operator of the selected transport vehicle 108 reviews the current image received with the message. If the operator determines that the current image shows a parcel, then at step 418 the drop box 102 is added to the transport vehicle's pick-up route. At step 420, the operator of the selected transport vehicle 108, retrieves the parcels, if any, from the drop box 102 and resets the parcel notification device 200, which returns to sleep mode at step 304. Optionally, the parcel notification device 200 may return to step 302 and capture a new reference image.

If the operator determines that the current image shows an object other than a parcel, such as a piece of garbage for example, then at step 422 a message is sent to the local agent 110, if one exists, to clear the drop box 102. At step 424, an employee at the local agent retrieves the garbage, if any, from the drop box 102 and resets the parcel notification device 200, which returns to sleep mode at step 304. Optionally, the parcel notification device 200 may return to step 302 and capture a new reference image.

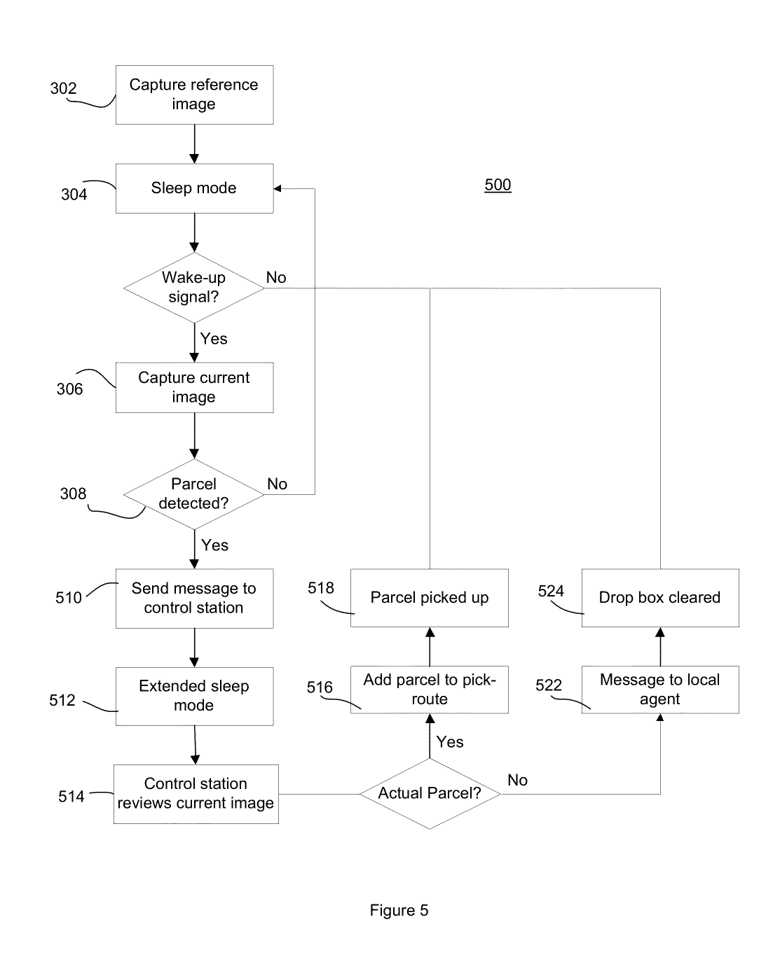

Referring to FIG. 5, a flow chart illustrating an alternate embodiment of the operation of the parcel notification device 200 is illustrated generally by numeral 500. As illustrated, steps 302 to 308 are the same as described in the embodiment described with reference to FIG. 3. Thus, at step 302, a reference image is captured by the camera 202 and stored in the memory 222. At step 304, the parcel notification device 200 enters a sleep or power saving mode until it receives a wake-up signal from the deposit sensor 208. Once the wake-up signal is received from the deposit sensor 208, then at step 306 the camera 202 captures a current image and stores it in the memory 222. At step 308, the processor 206 compares the current image with the reference image to determine if there is a difference. If the difference between the current image and the reference image is less than the difference threshold, the current image is deleted and the parcel notification device 200 returns to sleep mode 304. If the difference between the current image and the reference image is greater than the difference threshold, the drop box 102 is considered to possibly contain a parcel.

At step 510, a message is sent to the control station 106 indicating that the drop box 102 may contain a parcel. The message includes a drop box identifier and a copy of the current image. At step 512, the parcel notification device 200 enters the extended sleep mode.

At step 514 the control station 106 reviews the current image received with the message. The current image may be reviewed by an operator at the control station 106 or automatically analysed by an algorithm running on the control stations 106. If it is determined that the current image shows a parcel, then at step 516 the control station 106 instructs the select one of the transport vehicles 108 to add the drop box 102 to its pick-up route. At step 518, the operator of the selected transport vehicle 108, retrieves the parcels from the drop box 102 and resets the parcel notification device 200, which returns to sleep mode at step 304.

Optionally, the parcel notification device 200 may return to step 302 and capture a new reference image.

If it is determined that that the current image shows an object other than a parcel, such as a piece of garbage for example, then at step 520 a message is sent to the local agent 110, if one exists, to clear the drop box 102. If no local agent 110 exists the message is sent to the transport vehicle 108. At step 522, an employee at the local agent retrieves the garbage from the drop box 102 and resets the parcel notification device 200, which returns to sleep mode at step 304. Optionally, the parcel notification device 200 may return to step 302 and capture a new reference image.

Accordingly, it will be appreciated that the parcel notification device 200 described herein automatically notifies the central station 106 of a potential parcel for pick-up. The parcel notification device 200 has intelligent power management to extend battery life. Current results show potential battery life of a minimum of two weeks up to as much as six months. Further, the battery life can be extended with the option of external energy sources for supplemental power or batter recharging.

Although the invention is described with reference to certain embodiments, various modifications will be apparent. For example, although the embodiments described above delete the current image after the parcel notification device 200 has been reset, the current image may be stored. The current images can be stored until they are retrieved or until available space in the memory becomes limited. As another example, an alarm may trigger the parcel notification device 200 to wake from the extended sleep after a predefined time, regardless of whether it has been reset. As yet another example, the message transmitted to the control station 106 may also include battery information so that the battery can be replaced when required. As yet another example, the parcel notification device 200 may be configured to communicate directly with the closest transport vehicle rather than through the control station 206. As yet another example, the parcel notification device 200 may be reset remotely from the control station 106 if it is determined that the no parcels are actually present in the drop box 102.

Further, although the previous embodiments describe the drop box 102 as being configured to receive parcels for pickup by the parcel delivery service, the drop box 102 may also generally be described as a container configured to receive an item for pickup by a local service provider. For example, the drop box may be configured as a letter mail box configured to receive letters, or letters and parcels, for pickup by a local postal operator.

Using the foregoing specification, the invention may be implemented as a machine, process or article of manufacture by using standard programming and/or engineering techniques to produce programming software, firmware, hardware or any combination thereof.

Any resulting program(s), having computer-readable instructions, may be stored within one or more computer-usable media such as memory devices or transmitting devices, thereby making a computer program product or article of manufacture according to the invention. As such, functionality may be imparted on a physical device as a computer program existent as instructions on any computer-readable medium such as on any memory device or in any transmitting device, that are to be executed by a processor.

Examples of memory devices include, hard disk drives, diskettes, optical disks, magnetic tape, semiconductor memories such as FLASH, RAM, ROM, PROMS, and the like. Examples of networks include, but are not limited to, the Internet, intranets, telephone/modem-based network communication, hard-wired/cabled communication network, cellular communication, radio wave communication, satellite communication, and other stationary or mobile network systems/communication links.

A machine embodying the invention may involve one or more processing systems including, for example, computer processing unit (CPU) or processor, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

Using the description provided herein, those skilled in the art will be readily able to combine software created as described with appropriate general purpose or special purpose computer hardware to create a computer system and/or computer subcomponents embodying the invention, and to create a computer system and/or computer subcomponents for carrying out the method of the invention.

Although preferred embodiments of the invention have been described herein, it will be understood by those skilled in the art that variations may be made thereto without departing from the scope of the appended claims.

What is claimed is:

1. An automated item notification device configured to be secured within a drop box, the automated item notification device comprising:
a communication module configured to communicate with a remote resource
a deposit sensor configured to sense deposit of an object and provide a wake-up signal in response thereto;
a camera configured to capture an image of an interior of the drop box in response to the wake-up signal, and
a processor configured to:
compare the captured image with a previously acquired reference image stored in memory to determine if the object has been received in the drop box;
in response to detection that the objected has been received in the drop box, transmit a message to the remote resource that the drop box needs to be serviced, and enter an extended sleep mode; and
in response to detection that the objected has not been received in the drop box, enter a sleep mode.

2. The automated item notification device of claim 1, wherein the wake-up signal is sent to the processor, and the camera is configured to capture the image of the interior of the drop box in response to an instruction from the processor.

3. The automated item notification device of claim 1, wherein the wake-up signal is sent directly from deposit sensor to the camera.

4. The automated item notification device of claim 1, in which in the extended sleep mode the deposit sensor is inactive.

5. The automated item notification device of claim 2, in which in the extended sleep mode the processor does not communicate the wake-up signal to the camera.

6. The automated item notification device of claim 2, in which in the extended sleep mode the deposit sensor is inactive.

7. The automated item notification device of claim 1, in which in the extended sleep mode the processor requires an active reset to return to the sleep mode.

8. The automated item notification device of claim 1, in which in the extended sleep mode the processor returns to the sleep mode after a predefined time delay.

9. The automated item notification device of claim 1, in which all images are stored in memory until memory availability falls below a predefined threshold.

10. The automated item notification device of claim 1, in which the captured image is deleted when the processor enters the sleep mode.

11. The automated item notification device of claim 1, wherein the message includes a copy of the captured image.

12. The automated item notification device of claim 11, wherein the remote resource is a central control for distributing a pick-up request to a corresponding transport vehicle.

13. The automated item notification device of claim 11, wherein the remote resource is a corresponding transport vehicle.

14. The automated item notification device of claim 1, wherein the image is captured by the camera after a predefined sensor delay, the sensor delay being implemented by the deposit sensor delaying output of the wake-up signal.

15. The automated item notification device of claim 2, wherein the image is captured by the camera after a predefined sensor delay, the sensor delay being implemented by the processor delaying the instruction to the camera.

16. The automated item notification device of claim 3, wherein the image is captured by the camera after a predefined sensor delay, the sensor delay being implemented by the camera delaying capturing the image.

17. A method for automatically notifying a local service provider to service a drop box, the method comprising the steps of:
sensing deposit of an object by a deposit sensor;
providing a wake-up signal in response to the sensed deposit;
capturing an image of an interior of the drop box in response to the wake-up signal;
comparing the captured image with a previously acquired reference image stored in memory to determine if the object has been received in the drop box;
in response to detection that the objected has been received in the drop box, transmitting a message to a remote source and entering an extended sleep mode; and
in response to detection that the objected has not been received in the drop box, entering a sleep mode.

18. The method of claim 17, wherein the wake-up signal is sent to a processor and a camera is configured to capture the image of the interior of the drop box in response to an instruction from the processor.

19. The method of claim 17, wherein the wake-up signal is sent directly from deposit sensor to the camera.

20. The method of claim 17, in which in the extended sleep mode the deposit sensor is inactive.

21. The method of claim 18, in which in the extended sleep mode the processor does not communicate the wake-up signal to the camera.

22. The method of claim 18, in which in the extended sleep mode the deposit sensor is inactive.

23. The method of claim 17, in which in the extended sleep mode the processor requires an active reset to return to the sleep mode.

24. The method of claim 17, in which in the extended sleep mode the processor returns to the sleep mode after a predefined time delay.

25. The method of claim 17, in which all images are stored in memory until memory availability fall below a predefined threshold.

26. The method of claim 17, in which the captured image is deleted when the processor enters the sleep mode.

27. The method of claim 17, wherein the message includes a copy of the captured image

28. The method of claim 27, wherein the message is sent to a central control for distribution to a corresponding transport vehicle.

29. The method of claim 28, comprising the further steps of analyzing the message and, if it is determined that the object includes a desired item, then scheduling a pick-up for the drop box with a corresponding transport vehicle.

30. The method of claim 29, comprising the further step of an operator of the transport vehicle resetting the drop box so that it returns to the sleep mode.

31. The method of claim 29 comprising the further step of contacting a local agent to clear the drop box if it is determined that the object does not include the desired item.

32. The method of claim 31, comprising the further step of the local agent resetting the drop box so that it returns to the sleep mode.

33. The method of claim 27, wherein the message is sent directly to a corresponding transport vehicle.

34. The method of claim 17, wherein the image is captured after a predefined sensor delay, the sensor delay being implemented by the deposit sensor delaying output of the wake-up signal.

35. The method of claim 18, wherein the image is captured after a predefined sensor delay, the sensor delay being implemented by the processor delaying the instruction to the camera.

36. The method of claim 19, wherein the image is captured after a predefined sensor delay, the sensor delay being implemented by the camera delaying capturing the image.
